(19) United States
(12) Patent Application Publication
(10) Pub. No.: US 2011/0000611 A1
(43) Pub. Date: Jan. 6, 2011

(54) Method and Apparatus for Welding or Adhesively Bonding Together Areal Built-Structure Waterproofing Systems

(76) Inventor: Taieb Marzouki, Thedinghausen (DE)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/828,678

(22) Filed: Jul. 1, 2010

(30) Foreign Application Priority Data
Jul. 3, 2009 (DE) 10 2009 031 856.9
May 7, 2010 (DE) 10 2010 019 688.6

(51) Int. Cl. B29C 65/16; B32B 38/18

(52) U.S. Cl. 156/272.8; 156/380.9; 156/378

(57) ABSTRACT

Roof coverings are formed from underlayment membranes (12) and overlayment membranes (13) which are welded or adhesively bonded thereto. In order to weld the overlayment membrane (13) to the underlayment membrane (12), the welding surfaces (31, 32) to be joined are either melted by open flames from, for example, a gas burner or using hot air. Both open flames and hot air lead to an uncontrolled melting of the welding surfaces (31, 32). In addition, open flames can cause something catching fire. During adhesive bonding, protective films must previously be removed by hand from the adhesive layers. The invention provides for the welding surfaces (31, 32) of the underlayment membrane (12) and of the overlayment membrane (13) to be melted by infrared emitters (27) using in particular short-wave infrared beams. The infrared emitters (27) permit controlled and uniform melting of the welding surfaces (31, 32) over their entire width, which leads to homogeneous welding. In addition, no risk of fire is associated with the infrared emitters (27). During adhesive bonding of an overlayment membrane (13) to an underlayment membrane (12), the protective films are previously melted away by the infrared emitter (27).

### STATEMENT OF RELATED APPLICATIONS

This patent application is based on and claims the benefit of and convention priority on German Patent Application No. 10 2009 031 856.9 having a filing date of 3 Jul. 2009 and German Patent Application No. 10 2010 019 688.6 having a filing date of 7 May 2010, both of which are incorporated herein in their entireties by this reference.

### BACKGROUND OF THE INVENTION

1. Technical Field

The invention relates to a method for welding together areal built-structure waterproofing systems wherein at least one of the surfaces to be welded is softened by heating and they are welded together by subsequent pressing together of the surfaces, and for adhesively bonding together areal built-structure waterproofing systems wherein at least one surface of at least one of the built-structure waterproofing systems to be joined has an adhesive, in particular a cold self-adhesive, which is covered by a thin protective film which is removed before the joining to another built-structure waterproofing system. The invention furthermore relates to a corresponding apparatus for joining areal built-structure waterproofing systems with a heating device for heating at least one of the surfaces to be welded of the built-structure waterproofing systems or for removing a protective film on an adhesive layer of at least one of the built-structure waterproofing systems to be joined.

2. Prior Art

Areal built-structure waterproofing systems are used primarily for roofs, attics, walls and bridges. Usually waterproofing membranes which are rolled onto rolls are used here. A plurality of waterproofing membranes are placed one next to another and adhesively bonded or welded together to form a large-area waterproofing system. If multilayer roof waterproofing systems are used, underlayment membranes are welded or adhesively bonded to overlayment membranes.

If the built-structure waterproofing systems are welded together, at least one of the surfaces to be welded of the built-structure waterproofing system, in particular of the waterproofing membranes, is softened or melted by heating. The surfaces to be welded are subsequently pressed together to effect the weld. With bituminous built-structure waterproofing systems of preferably bitumen waterproofing membranes it is customary to heat and soften the surfaces to be welded using a burner having an open flame, preferably a gas burner. The open flame leads to an increased risk of something catching fire. The flame also results in an uncontrolled temperature development, as a result of which the surfaces to be welded are very difficult to heat uniformly, and no homogeneous weld joint is produced. Finally, the open flame can result in the bitumen burning, which leads to dangerous vapours which place the persons carrying out the welding procedure at risk and negatively impact the environment.

Waterproofing membranes made of plastic are usually welded together using hot air. Even this leads to an uncontrolled temperature development which does not permit uniform heating of the surfaces to be welded and thus leads to inhomogeneous welds. Heating the surfaces of the plastics waterproofing membranes to be welded using hot air involves the development of a great deal of smoke, which places the persons entrusted with the welding procedure at risk and pollutes the environment.

Built-structure waterproofing systems are adhesively bonded together using adhesive applied to the appropriate side of the built-structure waterproofing system, in particular waterproofing membrane. This adhesive is preferably cold self-adhesive (CSA). The adhesive can be disposed over the whole area of that side of the respective waterproofing membrane that is to be welded as a continuous layer or merely in regions, for example as strips or a grid of dots or the like. The adhesive bond of the waterproofing membrane comes about merely by pressing together the waterproofing membranes to be adhesively bonded.

For the waterproofing membranes to be capable of being rolled up, the adhesive which is active without heating, in particular cold self-adhesive, must be covered by a protective film, usually a silicone film or a siliconized plastics film. Before the waterproofing membrane is adhesively bonded, the protective film needs to be removed. The protective film is expensive, especially if it is a silicone film or a siliconized plastics film. Furthermore, the protective film which is pulled off the adhesive side of the respective waterproofing membrane must be disposed of.

### BRIEF SUMMARY OF THE INVENTION

The invention is now based on the object of providing a method and an apparatus, which can be used to weld together areal built-structure waterproofing systems reliably and uniformly, without risking persons and harming the environment, or to easily remove protective films from areal built-structure waterproofing systems to be adhesively bonded.

A method for welding together areal built-structure waterproofing systems, wherein at least one of the surfaces to be welded is softened by heating and they are welded together by subsequent pressing together of the surfaces, characterized in that the surfaces to be welded are at least heated using infrared beams is used to achieve this object. Using infrared beams for the welding process, the temperatures can be controlled exactly. As a result, the surfaces to be welded can be heated uniformly and both the plastic of plastics waterproofing systems and the bitumen of bitumen waterproofing systems can be uniformly softened or melted. The results are high-quality, in particular whole-area and homogeneous welds. Importantly, the invention enables even bituminous waterproofing systems to be welded together without an open flame. The infrared beams are used to weld together the surfaces to be welded without negatively impacting persons and without emissions which are harmful to the environment.

One preferred embodiment of the method provides for short-wave infrared beams to be used for welding. This ensures a particularly effective, uniform heating of the surfaces to be welded. Importantly, emitters generating short-wave infrared beams can be positioned relatively closely, and thus exactly, in front of the surfaces to be heated and melted, as a result of which the short-wave infrared beams can be directed onto the surfaces to be welded in a targeted fashion.

Provision is further made for the at least one of the surfaces to be welded to be heated or softened or melted continuously. In most cases, especially when two waterproofing membranes are intended to be welded together over their entire area or along the length of an overlap membrane, the two surfaces to be welded are heated and softened or melted. The continuous heating of at least one of the surfaces to be welded results, during laying, in the surfaces to be welded being uniformly brought into a state which is optimum for being welded together, as a result of which a homogeneous weld, in particular an uninterrupted welding seam, is produced.

If the built-structure waterproofing system is a waterproofing membrane which has been rolled onto a roll, a development of the method provides for the surface to be welded of at least the rolled-up waterproofing membrane to be continuously heated or melted while it is being unrolled from the roll. As a result, the at least one surface to be welded can be heated during unrolling of the waterproofing membrane, without the necessity for an additional work step.

One development provides for the at least one surface to be welded to be heated by at least one infrared emitter, in particular a short-wave infrared emitter, wherein this at least one infrared emitter is guided along in front of the roll preferably at a constant distance while the waterproofing membrane is being unrolled. As a result, at least the surface to be welded of the waterproofing membrane which has been unrolled from the roll can be heated directly before the welding while the waterproofing membrane is being unrolled. Heating and welding of the waterproofing membrane thus take place in one work step, as it were, while the waterproofing membrane is being unrolled from the roll.

If provision is made—as is the custom—for both surfaces to be welded to be softened or melted, this takes place, according to one preferred embodiment of the method, by simultaneous heating of these two surfaces. If, while the waterproofing membrane is being unrolled, its surface to be welded is heated, the other surface to be welded, on which the waterproofing membrane is being unrolled, is also heated. Provision may be made in this case for the surface of the rolled-up waterproofing membrane to be heated more or less than the surface whereby the waterproofing membrane is welded over the whole area or in a strip-wise fashion by an overlap seam. It is expedient especially if different materials are welded together to heat the surfaces to be welded to different extents. This creates optimum conditions for the production of a high-quality built-structure waterproofing system.

According to one preferred development of the method, provision is made for the maximum setpoint temperature to which the surfaces to be welded are heated to be monitored preferably continuously during heating. This ensures that the surfaces to be welded are heated to the intended setpoint temperature, without exceeding it. Rather, the setpoint temperature, or a setpoint temperature range, is always maintained, which is facilitated by the use of infrared emitters which are easily and exactly regulatable in terms of heating power.

A further preferred embodiment of the method provides, during heating of the surfaces to be welded, for the surface temperature of at least one of the surfaces to be heated to be especially continuously ascertained. This can be effected, for example, using a radiation pyrometer. A comparison of the measured, instantaneous temperature of the surface of at least one of the surfaces to be welded with the maximum setpoint temperature can lead to a reliable temperature regulation. This ensures that the surfaces to be welded are only heated as much as necessary. Heating which leads to burning is thus reliably avoided.

A further method for achieving the problem stated in the introduction is a method for adhesively bonding together areal built-structure waterproofing systems, wherein at least one surface of at least one of the built-structure waterproofing systems to be joined has an adhesive, in particular a cold self-adhesive, which is covered by a thin protective film which is removed before the joining to another built-structure waterproofing system, characterized in that the at least one protective film is thermally removed from the adhesive by means of infrared beams. According to this, provision is made for a protective film which covers the adhesive, in particular cold self-adhesive, for rolling up the membrane-type built-structure waterproofing system to be thermally removed by infrared beams. As a result, the protective film need no longer be pulled off the adhesive regions or the adhesive layer and disposed of before the built-structure waterproofing system is laid. The infrared beams melt the protective film, in particular melt it away, as a result of which the adhesive surfaces are exposed. There only remains a small residue of the melted adhesive of the protective film, which is easily disposed of.

According to the method according to the invention, a cheap, thin plastics film of a simple plastic, which does not need to be siliconized, can be used as the protective film. By way of example, it may be a polyethylene or polypropylene film having a thickness of less than 20 μm, preferably 5 μm to 10 μm. A thin film such as this can be melted on or melted away with little energy and thus be removed thermally from the adhesive.

Another advantage of the method according to the invention is that as a result of the melting of the protective film, which is effected using infrared beams, the adhesive, in particular cold self-adhesive, is warmed up or heated. This improves the effectiveness of the adhesive. Importantly, the method according to the invention permits built-structure waterproofing system to be adhesively bonded together using in particular cold self-adhesive at lower temperatures than has been the case to date.

A further preferred embodiment of the method relates to a built-structure waterproofing system in the form of a waterproofing membrane which is rolled up onto a roll. The protective film of the rolled-up waterproofing membrane is thermally removed by the at least one infrared emitter during unrolling of the waterproofing membrane. The waterproofing membrane is continuously unrolled during laying, wherein the protective film is thermally removed successively by the at least one infrared emitter during unrolling of the waterproofing membrane. This is done according to the method according to the invention at the same time as the unrolling during laying of the waterproofing membrane, as it were, specifically immediately before it is adhesively bonded.

According to a further preferred embodiment of the method, the protective film is removed by melting by the at least one infrared emitter. The infrared emitter is in particular a short-wave infrared emitter. The very thin protective film of plastic can be melted off easily by the at least one infrared emitter. In the process, the thin protective film shrinks, and as a result the adhesive layer or adhesive regions is/are exposed. The protective film shrinks due to the melting using the at least one short-wave infrared emitter to the extent that—save a small, compact plastic part—practically nothing remains of it.

An apparatus for achieving the object stated in the introduction is an apparatus for joining areal built-structure waterproofing systems with a heating device for heating at least one of the surfaces to be welded of the built-structure waterproofing systems or for removing a protective film on an adhesive layer of at least one of the built-structure waterproofing systems to be joined, characterized in that the heating device has at least one infrared emitter. According to this, a heating device is provided, which has at least one infrared emitter. Such infrared emitters can in the case of built-structure waterproofing systems to be welded be used to heat the surfaces to be welded in a targeted fashion and importantly uniformly over their entire width without leaving gaps. In addition, the heating energy from infrared emitters in particular in the short-wave range can be set exactly, with the result that the surfaces to be welded can be heated by the at least one infrared emitter to an exact temperature, this temperature being obtainable uniformly over the entire surface to be welded. This leads to optimum heating of the surfaces to be welded, which creates ideal conditions for a uniform welding together of the surfaces to be connected of built-structure waterproofing systems, in particular waterproofing membranes. In built-structure waterproofing systems to be adhesively bonded, the at least one infrared emitter serves for thermally removing the protective film from the adhesive regions or the adhesive layer by way of melting it off. As a result, the protective film need no longer be pulled off the adhesive manually and the pulled-off protective film need no longer be disposed of. In addition, during the thermal removal of the protective film, the adhesive is warmed up, whereby it is activated and a better adhesive bond is produced, in particular for lower temperatures. The at least one infrared emitter for removing the protective film does not need to generate as much thermal energy as is the case in infrared emitters for welding together built-structure waterproofing systems.

Provision is preferably made for the apparatus to have an unrolling device for unrolling at least one waterproofing membrane which is rolled onto a roll, wherein the at least one infrared emitter is associated with this unrolling device. As a result it is possible to heat at least one surface to be welded or to melt off the protective film using the at least one infrared emitter during unrolling of the waterproofing membrane to be welded or adhesively bonded to another waterproofing membrane or to some other underlayment. The at least one infrared emitter is here guided and moved further by the unrolling device exactly like the roll during unrolling of the waterproofing membrane.

Provision is preferably made for the unrolling device to be coupled to the roll of the waterproofing membrane, specifically to an unrolling axis of the roll which is formed through the longitudinal central axis thereof. Coupling the roll to the unrolling device thus permits simple unrolling of the waterproofing membrane from the roll.

According to a preferred embodiment of the invention, provision is made for at least one spacer to be associated with the unrolling device. The spacer ensures that the at least one infrared emitter at the unrolling device always has approximately the same distance from the roll and thus from the surface to be welded or the protective film to be melted of the rolled-up waterproofing membrane, even if the diameter of the roll decreases steadily during unrolling of the waterproofing membrane. The same or an additional spacer may be provided for keeping the distance of the at least one infrared emitter from the surface to be heated constant. This is true especially if the same infrared beams heat or melt the surfaces to be welded or the protective films of the two waterproofing membranes to be connected.

A further preferred embodiment of the apparatus provides for the unrolling device to be in the form of an unrolling carriage which can travel on an underlayment to which the waterproofing membrane to be unrolled is to be joined. The unrolling carriage permits continuous unrolling of the waterproofing membrane, wherein owing to the attachment of the at least one infrared emitter on the unrolling carriage the surface to be welded or the protective film of the waterproofing membrane to be unrolled continuously softens or melts away and the at least one infrared emitter is guided with a constant distance from the underlayment on which the waterproofing membrane to be unrolled is to be applied. If the at least one infrared emitter heats or melts away also the second surface or protective film, the unrolling carriage also ensures a constant distance of the at least one infrared emitter to this second surface.

The unrolling carriage is preferably configured such that it is guided by hand. The unrolling carriage is furthermore configured such that it can be pushed by the operator or that it can travel autonomously by way of a drive.

Provision is further preferably made for the at least one infrared emitter to be arranged at the leading side of the unrolling carriage, when viewed in the unrolling direction of the waterproofing membrane to be unrolled. As a result, the at least one infrared emitter can heat the respective surface to be heated or the respective protective film of at least the waterproofing membrane to be unrolled directly on the underside using direct heat irradiation.

One development of the apparatus provides for the unrolling carriage to have at least one temperature measuring device, preferably a radiation pyrometer, which ascertains the surface temperature of at least one of the surfaces to be welded. As a result, the surface temperature of at least one surface to be heated can be measured preferably continuously during unrolling of the waterproofing membrane. The surface temperature, by comparing it to the setpoint temperature, can be used to select, in particular regulate, the heating power of the at least one infrared emitter and/or the unrolling rate of the waterproofing membrane to be unrolled or the speed at which the unrolling carriage is moved further by the drive such that one or both of the surfaces to be welded is/are heated to the intended, optimum temperature. As a result, a controlled and uniform heating of the surfaces to be welded is brought about and in addition excessive heating is reliably avoided. The same is true for the case that the at least one infrared emitter thermally removes the protective film by melting from at least one of the two waterproofing membranes to be connected.

### BRIEF DESCRIPTION OF THE DRAWINGS

Preferred exemplary embodiments of the invention will be explained in further detail below using the drawing, in which:

FIG. 1 shows a plan view of a roof cover which is partially laid, and

FIG. 2 shows a schematic side view of an apparatus for connecting roof waterproofing membranes.

### DETAILED DESCRIPTION OF PREFERRED EMBODIMENTS

The figures show the invention in connection with a roof waterproofing system. The invention is not limited to this, however. It is suitable for any built-structure waterproofing systems, for example including bridge waterproofing systems, attic or wall waterproofing systems and connections.

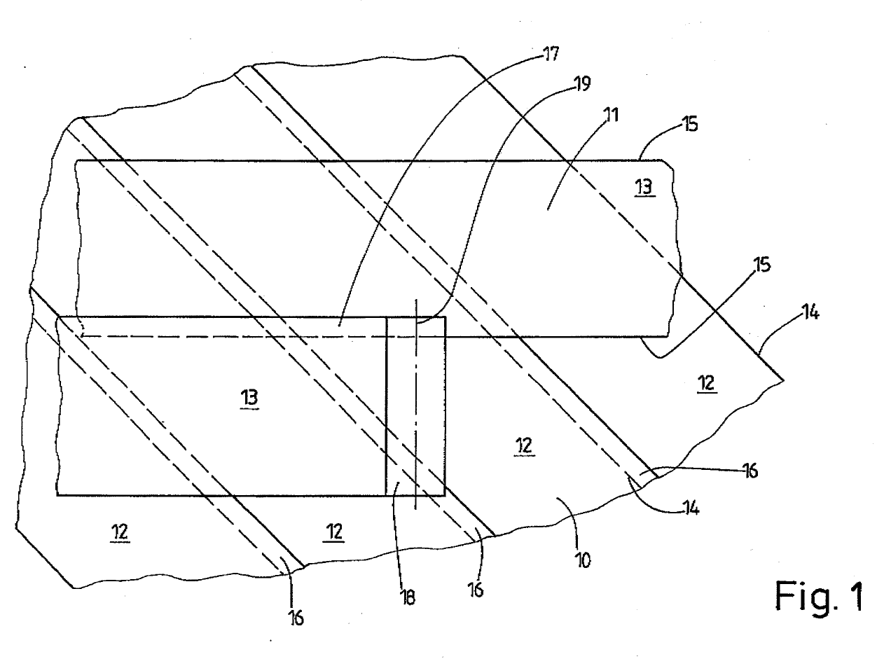

The roof waterproofing system shown in FIG. 1 is of two-layered design. To this end, an underlayment layer 10 is arranged on an insulation (not shown), and on said layer an overlayment layer 11. Both the underlayment layer 10 and the overlayment layer 11 are formed from adjacent roof waterproofing membranes, specifically underlayment membranes 12 and overlayment membranes 13. The underlayment membranes 12 and the overlayment membranes 13 can be arranged on top of one another with different orientations. In the exemplary embodiment shown, the overlayment membranes 13 are arranged on top of the underlayment membranes 12 such that the longitudinal edges 14 of the underlayment membranes 12 and the longitudinal edges 15 of the overlayment membranes 13 intersect at an angle of approximately 45°, for example.

Both the underlayment membranes 12 and the overlayment membranes 13 are laid with little lateral overlap and are welded together in the region of the overlaps by way of overlap seams 16 and 17. Moreover, the overlayment membranes 13 are welded over the whole area on the underlayment membranes 12 such that a whole-area weld joint of the overlayment layer 11 with the underlayment layer 10 results.

Welding of the adjacent underlayment membranes 12 in the regions of the overlap seams 16 and of the adjacent overlayment membranes 13 in the region of the overlap seams 17 and the whole-area welding of the overlayment membranes 13 on the underlayment membranes 12 take place, according to the invention, using infrared beams, specifically with preference short-wave infrared beams which are generated by at least one elongate infrared emitter which is electrically operated. The respective infrared emitter is used to heat both the surfaces to be welded or possibly only one of the surfaces to be welded to a specific temperature, which is or are softened or melted as a result.

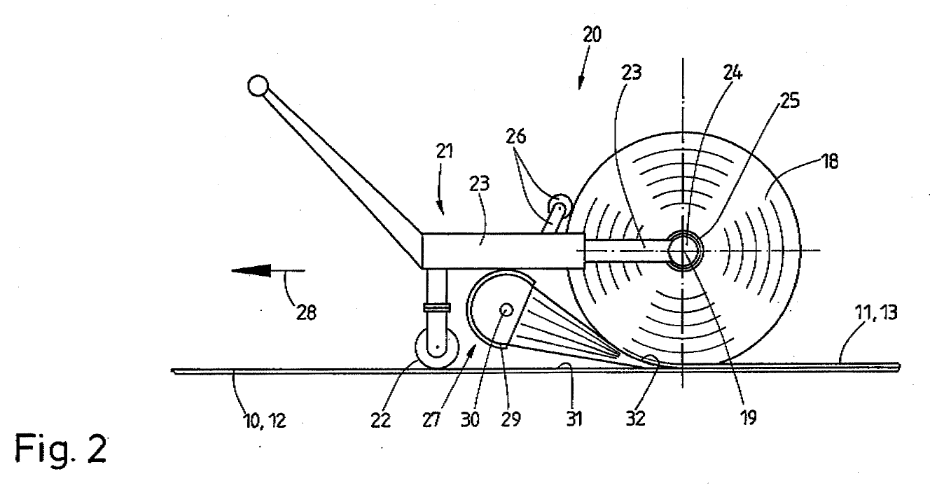

FIG. 2 schematically illustrates an apparatus for welding together the underlayment membranes 12 and the overlayment membranes 13 using an infrared emitter 18 for heating the two surfaces to be welded. In the exemplary embodiment shown, the apparatus is used to weld an overlayment membrane 13 over the whole area to the previously laid underlayment membranes 12 of the underlayment layer 10 while producing the overlap seam 17 for joining adjacent overlayment membranes 13 at the same time. The overlayment membrane 13 to be welded is unrolled off a roll 18 in the process. The roll 18 rotates here about its longitudinal central axis 19. In the process, the longitudinal central axis 19 of the roll 18 forms at the same time an unrolling axis.

The apparatus has, in the exemplary embodiment shown, an unrolling device in the form of an unrolling carriage 20. The unrolling carriage 20 has a frame 21 having freely rotatable wheels 22, on which the unrolling carriage 20 can be moved, in particular pushed, on an underground via manual operation and manual guidance. The unrolling carriage 20 can also have a travel drive, however. In that case, the unrolling carriage 20 is self-moving and only needs to be guided by hand. In the exemplary embodiment shown, the unrolling carriage 20 can travel with the wheels 22 in the longitudinal direction of the overlayment membrane 13 to be laid on the underlayment layer 10.

The unrolling carriage 20 has in each case one arm 23 at opposite ends of the frame 21. A mandrel 24, which has a transverse orientation, is arranged at the free end of each arm 23. The mandrels 24 engage from opposite sides into a hollow axle 25 of each roll 18 of the overlayment membrane 13. The hollow axle 25, which can be formed, if appropriate, from a tube on which the overlayment membrane 13 is wound, is located on the longitudinal central axis 19 of the roll 18, which thus forms a rotational axis of the unrolling axis about which the roll 18 on the mandrels 24 which are likewise located on the longitudinal central axis 19 can be rotated freely. As a result, the roll 18 can be unwound by moving the unrolling carriage 20 along in the laying direction 28 of the roll 18 extending in the longitudinal direction of the overlayment membrane 13.

The unrolling carriage 20 shown here preferably has a plurality of spacers 26 fixed on the frame 21. These spacers bear outwardly against the roll 18, preferably by way of a freely rotatable wheel or a roller. The spacers 26 can serve for shortening the arms 23, which may have a telescopic design, as the outer diameter of the roll 18 decreases through further unrolling of the overlayment membrane 13 from the roll 18. In this way, the roll 18 is in constant contact with the spacers 26 even if its diameter changes.

At least one elongate infrared emitter 27 is additionally arranged on the unrolling carriage 20. This can be a single infrared emitter 27 extending over the entire width of the roll 18 with the overlayment membrane 13. However, it is likewise conceivable to provide a plurality of shorter infrared emitters 27 which are located one next to another, i.e. arranged in a row, on a common axis extending transversely to the laying direction 28. In addition, it is also possible for a plurality of infrared emitters 27 to be arranged in parallel formation, i.e. above and/or behind one another, in which case a plurality of infrared emitters 27 can also be arranged next to one another. In this case, a plurality of infrared emitters 27 are arranged in a row and parallel to one another to form a grid of a plurality of infrared emitters 27. At least the external infrared emitters 27 have in that case a width which corresponds to the width of the overlap seam 16 or 17, with the result that the same apparatus can be used to effect not only a whole-area adhesive bond of the overlayment membrane 13 to the underlayment membrane 12, but also a welding together of neighbouring underlayment membranes 12 and/or overlayment membranes 13 in the region of the respective overlap seam 16 and 17, for which only one external infrared emitter 27 is then operated.

The infrared emitter 27 has a reflector 29, the cross section of which is such that the reflector 29 bundles or focuses infrared beams and directs them onto the two surfaces to be welded, specifically, in the exemplary embodiment illustrated, the upper side of the underlayment layer 10 and the bottom side of the overlayment membrane 13 to be welded onto the former. For this, the reflector 29, in the exemplary embodiment illustrated, has an approximately half-cylindrical design. The inner surface of the reflector 29 is configured such that it favours the reflection of the infrared beams. To this end, for example, the inside of the reflector 28 is provided with a golden or silver-coloured coating.

Arranged in the center of the reflector 29 is an elongate heating coil 30 of the infrared emitter 27, which heating coil extends continuously over the entire length of the infrared emitter 27. It is also conceivable that a plurality of parallel heating coils 30 are arranged in close proximity to one another near the centre of the reflector 29. The heating coils 30 are electrically operated by being made to glow in the manner of a resistance heating by the current flowing through the heating coils 30, and in the process generating infrared beams which are directed by the reflector 29 onto the surfaces to be welded. A continuous line or narrow band is formed over the entire width of the overlayment membrane 13 by the at least one heating coil 30, which extends over the entire length of the infrared emitter 27, using infrared beams which heat the overlayment membrane 13 and the underlayment membrane 12 continuously and uniformly over the entire width.

At least one temperature sensor (not shown in FIG. 2), which ascertains the surface temperature of at least one of the surfaces to be welded which are heated by the infrared emitter 27, specifically the welding surfaces 31 and 32 in FIG. 2, can also be arranged on the unrolling carriage 20. This can be, by way of example, a radiation pyrometer.

Other apparatuses which serve, for example, only for producing the overlap seams 16 and 17 are feasible. In that case, the unrolling carriage 20 has only a relatively short or narrow infrared emitter 27 which extends only over the region of the relatively narrow overlap seam 16 or 17. If appropriate, the unrolling carriage 20 can have two short infrared emitters 27 at its opposite ends, as a result of which overlap seams 16 and 17 can be produced at any desired ends of the roll 18 of the overlayment membrane 13 or of another waterproofing membrane.

For the production of connections, a small apparatus is conceivable, which is not in the form of an unrolling carriage 20. It is in this case a hand-held appliance with only at least one relatively short infrared emitter. A frame 21 with mandrels 24 for holding the roll 18 to be unwound is not included in this hand-held appliance. The hand-held appliance does not need to have a frame 21 for unwinding a roll 18, since usually only narrow sealing strips are used to form connections. This hand-held appliance also has no wheels 22 because, due to the merely relatively short infrared emitter, it is relatively light-weight and can thus be guided well by hand.

The method according to the invention will be explained in more detail below with reference to FIGS. 1 and 2.

The figures show the whole-area adhesive bond of an overlayment layer 11 of overlayment membranes 13 which are unrolled next to one another with an overlap of the longitudinal edges 15 with an underlayment layer 10 of underlayment membranes 12 which are located one next to the other. The upper side of the underlayment layer 10 is welded over the whole area to the bottom side of the overlayment membranes 13 which are located one next to the other and form the overlayment layer 11. In the process, the surfaces to be welded, specifically the welding surfaces 31 of the underlayment membrane 12 and the welding surfaces 32 of the overlayment membrane 13, are heated according to the invention by at least one infrared emitter 27 over the whole area, specifically continuously over the entire width of the overlayment membrane 13, and thus softened and melted, and subsequently the melted welding surfaces 31 and 32 are welded together. Heating of the welding surfaces 31 and 32 by the at least one infrared emitter 27 and joining of the welding surfaces 31 and 32 which are melted in this manner take place continuously while the overlayment membrane 13, which is rolled up on the roll 18, is unrolled on the underlayment layer 10 which is formed by the underlayment membranes 12.

The at least one electrically operated infrared emitter 27 generates short-wave infrared beams which are bundled or focused by the reflector 29 and directed onto the welding surfaces 31 and 32, specifically just before the bottom side of the overlayment membrane 13 to be unrolled is placed onto the upper side of the underlayment layer 10. In the case of whole-area adhesive bonding of the overlayment layer 11 to the underlayment layer 10, the overlayment membrane 13 is heated and thus softened and melted over the entire width by infrared beams which are generated by the at least one elongate heating coil 30 which extends over the entire width of the overlayment membrane 13. The at least one infrared emitter 27 is orientated exactly by the unrolling carriage 20 such that it heats the welding surfaces 31 and 32 using infrared beams in a targeted fashion.

Since the unrolling carriage 20 with its mandrels 24 holds the roll 18 in the hollow axle 25, the continued movement of the unrolling carriage 20 in the laying direction 28 causes the roll 18 to unwind and in the process the overlayment membrane 13 to be laid on the underlayment layer 10. During the unwinding of the overlayment membrane 13, the welding surfaces 31 and 32 of the overlayment membrane 13 of the underlayment layer 10, which welding surfaces 31 and 32 are heated and softened by the infrared beams, come into whole-area contact with each other, as a result of which an uninterrupted, whole-area and homogeneous welding of the overlayment membrane 13 to the underlayment layer 10 occurs.

The spacers 26 and unrolling carriage 20 ensure that the distance between the roll 18 and the at least one infrared emitter 27 remains constant. However, since the diameter of the roll 18 decreases with the unrolling of the overlayment membrane 13, in a preferred embodiment of the method the distance can be kept the same by always shortening the arms 23 of the unrolling carriage 20 which carry the mandrels 24 such that the roll 18 bears against the spacers 26. The unrolling carriage 20 with the roll 18 of the overlayment membrane 13 attached thereto is moved by hand in the laying direction 28. For this purpose, the unrolling carriage 20 can be moved along with the wheels 22 on the underlayment layer 10.

The unrolling carriage 20 can also have guides which serve for unrolling the overlayment membrane 13 always parallel to the overlayment membranes 13 which have already been laid, such that the width of the overlap seam 17 between overlayment membranes 13, which are laid next to one another with an overlap, is always the same. In the region of this overlap seam 17, the overlayment membranes 13 which are located one next to the other are likewise welded together. This welding is carried out at the same time as the whole-area welding of the overlayment membranes 13 to the underlayment layer 10.

It is also conceivable to equip the rolling carriage 20 with at least one temperature sensor (not shown). The temperature sensor preferably measures the surface temperature of at least one of the welding surfaces 31 and 32. This can be done, for example, by way of a radiation pyrometer. The measured surface temperature is compared to the setpoint temperature provided for welding either manually by the operator of the unrolling carriage 20 or automatically by an electronic open-loop or closed-loop controller. Depending on whether the setpoint temperature is exceeded or undershot, either the heating power of the at least one infrared emitter 27 is adjusted and/or the speed at which the unrolling carriage 20 with the roll 18 of the overlayment membranes 13 is moved in the laying direction 28 is changed. If the setpoint temperature for welding the overlayment membrane 13 to the underlayment layer 10 is kept constant by an open-loop or closed-loop controller, it is expedient for the unrolling carriage 20 to be provided with a drive, with the result that the controller can influence the speed of the self-driving unrolling carriage 20.

The manner described above is used to heat and thus melt, using infrared beams, the welding surfaces as well for forming the overlap seams 16 and 17 between neighbouring underlayment membranes 12 and overlayment membranes 13 for welding the double-layered underlayment membrane 12 or overlayment membrane 13 in the region of the respective overlap seam 16 and 17, respectively. In this case, however, the unrolling carriage 20 only needs to have a narrow infrared emitter which extends only transversely over the width of the overlap seam 16 or 17.

Connections, preferably built-structure or roof connections, are produced entirely by hand. However, the welding surfaces of the waterproofing strips to be joined are heated here as well by way of infrared beams from at least one infrared emitter and are thus softened or melted before the welding operation.

The method according to the invention is suitable not only for welding overlayment membranes 13 to underlayment membranes 12. The method can also be used, for example, in built-structure waterproofing systems, in particular bridge waterproofing systems, in order to lay waterproofing membranes on an appropriately prepared weldable substrate and to weld them at least in the region of overlap seams.

The invention is furthermore suitable for heating the surfaces to be welded of waterproofing membranes of various materials, specifically both bituminous waterproofing membranes and plastics waterproofing membranes.

The invention also relates to the adhesive bonding, in particular cold adhesive bonding, of built-structure waterproofing systems such as preferably rollable waterproofing membranes. By way of example, overlayment membranes 13 and underlayment membranes 12 can be joined by way of in particular cold adhesive bonding in the manner shown in FIG. 1.

For adhesively bonding the overlayment membranes 13 to the underlayment membranes 12, both the upper sides of the underlayment membranes 12 and the bottom sides of the overlayment membranes 13 can be provided with adhesive, in particular cold self-adhesive. To this end, both the upper sides of the underlayment membranes 12 and the bottom sides of the overlayment membranes 13 can be provided with a whole-area adhesive layer, in particular a cold self-adhesive layer. However, it is also conceivable, in particular in roofing restorations, for only the bottom sides of the overlayment membranes 13 to have an adhesive layer, in particular a cold self-adhesive layer, but not the upper sides of the underlayment membranes 12. It is also conceivable that the upper sides of the underlayment membranes 12 and/or the bottom sides of the overlayment membranes 13 do not have whole-area adhesive layers, in particular cold self-adhesive layers, but to be provided with adhesives only in regions. By way of example, the upper sides of the underlayment membranes 12 and/or the bottom sides of the overlayment membranes 13 can be provided with adhesive, in particular cold self-adhesive, only in regions, for example by strips or dots of any desired surfaces. The dimensions of the strips or patterns can be as desired.

It is assumed in the following description that both the upper sides of the underlayment membranes 12 and the bottom sides of the overlayment membranes 13 are provided over the whole area with a cold self-adhesive layer. The overlayment membranes 13 and the underlayment membranes 12 are then bonded together using cold adhesive on both surfaces which face each other.

For rolling up the underlayment membranes 12 and the overlayment membranes 13 which are coated with a cold self-adhesive, the cold self-adhesive layers are covered over the whole area by protective films (not shown in the figures). The protective films are plastics films, preferably polyethylene films or polypropylene films. The protective films have merely a relatively small thickness of less than 20 μm, in particular 5 μm to 10 μm. The thickness of the protective films is preferably merely 7 μm to 8 μm.

The protective films, which are not siliconized, are, according to the invention, thermally removed preferably continuously by at least one infrared emitter before the overlayment membranes 13 are adhesively bonded to the underlayment membranes 12. To this end, the protective films are heated by the infrared emitter to such an extent that they melt away and in the process expose the cold self-adhesive layers at least for the most part. Since the infrared emitters need only melt away the very thin protective films, they can have a lower heating power than the infrared emitters 27 for welding the overlayment membranes 13 to the underlayment membranes 12. Suitable infrared emitters for melting away the protective films are preferably also short-wave infrared emitters.

The heat generated by the infrared emitters for melting away the protective film also leads to a heating of at least external partial regions of the cold self-adhesive layers under the overlayment membranes 13 and on the underlayment membranes 12. This results in an activation of the cold self-adhesive layers and a resulting more effective cold adhesive bond between the overlayment membranes 13 and the underlayment membranes 12. This is true in particular for low temperatures. The warming up of at least the surfaces to be adhesively bonded of the cold self-adhesive layers during the removal of the protective films from the cold self-adhesive layers can cause the overlayment membranes 13 to be adhesively bonded to the underlayment membranes 12 using cold self-adhesives at lower temperatures than is possible during the customary cold adhesive bonding of overlayment membranes 13 to underlayment membranes 12.

Removal of the protective films from the adhesive surfaces of the cold self-adhesive layers by at least one infrared emitter can take place for example using the apparatus shown in FIG. 2. This apparatus has one or more infrared emitters 27 which are arranged on the frame 21 of the unrolling carriage 20. The unrolling carriage 20 takes up a roll of the overlayment membrane 13. The latter is unrolled on the already laid underlayment membrane 12 using the hand-guided and pushed or self-driving unrolling carriage 20, specifically and preferably in the manner shown in FIG. 1, as described in relation to this figure.

During the unrolling of the overlayment membrane 13, which takes place using the unrolling carriage 20, on the already laid underlayment membrane 12, the protective film (not shown in FIG. 2) is still present on the upper side of the underlayment membrane 12. The protective film is also still present during unrolling of the overlayment membrane 13 on the bottom side of the overlayment membrane 13 to be adhesively bonded to the underlayment membrane 12. In the exemplary embodiment shown here, the protective films are thus located on the welding surfaces 31 and 32 of the first exemplary embodiment shown in FIG. 2.

Just like the welding surfaces 31 and 32 according to the first exemplary embodiment of the invention, the protective films are heated by the infrared emitter 27. A heating cone from the infrared emitter 27 is to this end directed into a gap which forms between the overlayment membrane 13 and the underlayment membrane 12 during the unrolling operation of the overlayment membrane 13 on the underlayment membrane 12. As a result, the infrared emitter 27 simultaneously heats both protective films on the bottom side of the overlayment membrane 13 and the upper side of the underlayment membrane 12. The protective films are heated by the infrared emitter 27 to such an extent that they are melted. Here, the protective films are thermally removed from the cold self-adhesive surfaces to be joined on the upper side of the underlayment membrane 12 and the bottom side of the overlayment membrane 13. This may be referred to as melting away, wherein the protective films expose the surfaces to be adhesively bonded of the cold self-adhesive layers of the underlayment membranes 12 and the overlayment membranes 13 by melting away from the surfaces. What remains of the protective films is merely shrink-melted compact particles which—if at all—can be disposed of easily since they have only a very small volume.

While the protective films melt, the cold self-adhesive layers warm up at least to some extent. At least their outer surfaces which come into contact for adhesively bonding the underlayment membrane 12 to the overlayment membrane 13 are pre-warmed in the process and thus the self-adhesiveness of the cold self-adhesive layers is improved. In particular, a more effective adhesive bond of the overlayment membrane 13 to the underlayment membrane 12 is thus ensured at relatively low temperatures. The adhesive bonding can, as per the method according to the invention, also take place at lower temperatures than with the prior customary cold adhesive bonding of built-structure waterproofing systems.

The at least one infrared emitter 27 has sufficient thermal energy for melting on and melting away the protective films from the underlayment membrane 12 and the overlayment membrane 13, wherein the cold self-adhesive layers are necessarily warmed up or heated at least on the outsides.

The method described above is used also when the sides to be adhesively bonded of the underlayment membrane 12 and of the overlayment membrane 13 are provided with cold self-adhesive only in regions, specifically cold self-adhesive strips or cold self-adhesive dots. The protective films can in that case as well extend continuously over the entire available surfaces of the underlayment membrane 12 and the overlayment membrane 13, but also only in the regions of the cold self-adhesive. If protective films are present only in these regions of cold self-adhesives, they are melted away, too, by the infrared emitters 27, and outside the region-wise protective films the exposed regions of the upper side of the underlayment membranes 12 and the bottom side of the overlayment membranes 13 are warmed up by the at least one infrared emitter 27.

The invention is suitable also for the case that only one of the roof membranes to be joined is provided entirely or partially with cold self-adhesive. In particular in the case of roof restoration, where a new overlayment membrane 13 is applied to the already present underlayment membrane 12, only the bottom side of the overlayment membrane 13 has a cold self-adhesive which is covered by a protective film. In that case, only this protective film needs to be thermally removed by the at least one infrared emitter 27. To this end, it is also possible to use the apparatus shown in FIG. 2, wherein the at least one infrared emitter 27 not only melts away the protective film on the bottom side of the overlayment membrane 13, but also warms up the upper side of the underlayment membrane 12 without a protective film and cold self-adhesive. This also benefits the cold adhesive bond of the overlayment membrane 13 to the underlayment membrane 12. However, it is also conceivable to position in this case the infrared emitter 27 on the unrolling carriage 20 such that it is directed only at the protective film under the overlayment membrane 13 but not at the upper side of the underlayment membrane 12. In that case, the infrared emitter 27 only melts away the protective film under the overlayment membrane 13 and warms up the cold self-adhesive layer under the overlayment membrane 13, but not the upper side of the underlayment membrane 12.

The above-described method for laying in particular cold self-adhesive waterproofing membranes, mainly overlayment membranes 13 and underlayment membranes 12, is also suitable for producing built-structure and roof connections. Here, a small apparatus, in particular a hand-held appliance, is used rather than the unrolling carriage 20. This hand-held appliance preferably has only a single small infrared emitter. The hand-held appliance is used to remove the protective films as well thermally from the bottom side of the overlayment membranes 13 and/or the upper side of the underlayment membranes 12. This occurs due to melting off or melting away of the protective film as a result of the thermal energy emitted by the infrared emitter onto the former. The infrared emitter of the hand-held appliance can likewise serve for warming up, at least on the outside, and thus activating the cold self-adhesive, as a result of which the adhesive bond is improved in particular at relatively low temperatures.

### List of References

10 underlayment layer
11 overlayment layer
12 underlayment membrane
13 overlayment membrane
14 longitudinal edge (of 12)
15 longitudinal edge (of 13)
16 overlap seam
17 overlap seam
18 roll
19 longitudinal central axis
20 unrolling carriage
21 frame
22 wheel
23 arm
24 mandrel
25 hollow axle
26 spacer
27 infrared emitter
28 laying direction
29 reflector
30 heating coil
31 welding surface
32 welding surface

What is claimed is:

1. A method for welding together areal built-structure waterproofing systems, comprising:
softening at least one of the surfaces to be welded by heating, and
welding the surfaces together by subsequent pressing together of the surfaces,
wherein the surfaces to be welded are at least heated using infrared beams.

2. The method according to claim 1, wherein the at least one surface to be welded is at least heated using short-wave infrared beams.

3. The method according to claim 1, wherein the at least one surface to be welded is at least heated continuously using infrared beams.

4. The method according to claim 1, wherein at least one of the surfaces to be welded is a waterproofing membrane, which is rolled up to form a roll (18), and is heated continuously while the waterproofing membrane is unrolled from the roll (18).

5. The method according to claim 4, wherein two surfaces are to be welded and the two surfaces to be welded are at least heated simultaneously.

6. The method according to claim 4, wherein the at least one surface to be welded is heated by at least one infrared emitter (27), wherein this at least one infrared emitter (27) is guided along the waterproofing membrane in front of the roll (18) while the roll (18) is being unrolled.

7. The method according to claim 6, wherein while the waterproofing membrane is unrolled from the roll (18), the at least one infrared emitter (27) and the roll (18) are moved along together, and in the process, while the waterproofing membrane is being unrolled, at least the surface to be welded of the unrolled waterproofing membrane is at least heated.

8. The method according to claim 4, wherein at the same time as the surface to be welded of the waterproofing membrane which has been unrolled from the roll (18), the surface to which the waterproofing membrane is welded is also at least heated.

9. The method according to claim 1, wherein the maximum setpoint temperature to which at least one of the surfaces to be welded is heated is monitored during the heating of the surface.

10. The method according to claim 9, wherein during heating of at least one of the surfaces to be welded the surface temperature of at least the surface to be heated is continuously ascertained and compared to the setpoint temperature.

11. A method for adhesively bonding together areal built-structure waterproofing systems, wherein at least one surface of at least one of the built-structure waterproofing systems to be joined has an adhesive which is covered by a thin protective film which is removed before the joining to another built-structure waterproofing system, comprising thermally removing the at least one protective film from the adhesive by means of infrared beams.

12. The method according to claim 11, wherein the protective film is thermally removed from the respective built-structure waterproofing system by way of melting using the infrared beams.

13. The method according to claim 11, wherein the protective film is thermally removed using infrared beams from at least one built-structure waterproofing system in the form of a waterproofing membrane which is rolled up onto a roll.

14. The method according to claim 13, wherein the protective film is thermally removed continuously from the waterproofing membrane which is rolled onto a roll using infrared beams while the respective waterproofing membrane is unrolled which takes place for the purpose of being laid.

15. An apparatus for joining areal built-structure waterproofing systems comprising a heating device for heating at least one of the surfaces to be welded of the built-structure waterproofing systems or for removing a protective film on an adhesive layer of at least one of the built-structure waterproofing systems to be joined, wherein the heating device has at least one infrared emitter (27).

16. The apparatus according to claim 15, further comprising an unrolling device, wherein the at least one infrared emitter (27) is associated with the unrolling device for unrolling at least one waterproofing membrane which is rolled onto a roll (18).

17. The apparatus according to claim 16, wherein the unrolling device is coupled to the roll (18) of the waterproofing membrane.

18. The apparatus according to claim 16, wherein the unrolling device has spacers (26) with respect to the surface to be heated of the waterproofing membrane which is rolled onto the roll (18).

19. The apparatus according to claim 16, wherein the unrolling device has spacers (26) with respect to the at least one protective film to be removed of the waterproofing membrane.

20. The apparatus according to claim 16, wherein the unrolling device is in the form of an unrolling carriage (20) which can travel on an underlayment to which the waterproofing membrane to be unrolled is to be joined.

21. The apparatus according to claim 20, wherein the at least one infrared emitter (27) is arranged in front of the roll (18) on a front face of the unrolling carriage (20) when viewed in the unrolling direction of the waterproofing membrane.

22. The apparatus according to claim 20, further comprising at least one temperature measuring device arranged on the unrolling carriage (20).
